(19) United States
(12) Patent Application Publication
(10) Pub. No.: US 2024/0403830 A1
(43) Pub. Date: Dec. 5, 2024

(54) SYSTEM AND METHOD FOR IMPROVED TRACKING AND ACCESSIBILITY OF PROJECT DEVELOPMENT

(71) Applicant: PLP UTVIKLING AS, Oslo (NO)

(72) Inventor: Bjørn Gustav Nielsen, Oslo (NO)

(21) Appl. No.: 18/678,561

(22) Filed: May 30, 2024

Related U.S. Application Data
(60) Provisional application No. 63/470,392, filed on Jun. 1, 2023.

(51) Int. Cl. G06Q 10/10; G06F 21/31

(52) U.S. Cl. CPC G06Q 10/103; G06F 21/31

(57) ABSTRACT

A system and method for improved tracking and accessibility of project development comprising: at least one project module; an active information module for searching, retrieving and storing information relevant to the at least one project module comprising a verification program for assessing a validity of said relevant information; and a blockchain module comprising blockchain, the blockchain module in data communication with the at least one project module and configured to irreversibly record actions carried out that are associated with the project module; wherein the at least one project module is accessible by an authenticated user; and wherein the blockchain module is accessible by a verified independent user.

### CROSS-REFERENCE TO RELATED APPLICATIONS

The present disclosure is based on and claims benefit from co-pending U.S. Provisional Patent Application No. 63/470,392 filed Jun. 1, 2023 and entitled “System and Method for Improved Project Development” the contents of which are incorporated herein in their entirety by reference.

### BACKGROUND

There exist challenges in processes and projects due to lack of transparency and personal responsibility. Experience shows that management of many projects, in particular those of long duration, do not have sufficient understanding of arising problems due to complexity and missing overview. Hence it is not possible to comprehend sufficient understanding prior to taking vital decisions that arise along said project. It may be technically difficult to obtain sufficient transparency in a long-term project where there is no common platform. In some cases, it may also be difficult to obtain sufficient transparency wherein this was not in the interest of some parties associated with said projects, for example, wherein transparency may expose corruption. Furthermore, decisions taken may result from inaccurate information.

A few illustrative examples which may use input data from a hierarchy of decision makers are as follows. In a first illustrative example, the project is an infrastructure project, for example building a bridge or an apartment complex. In a second illustrative example, the project is a social welfare project, for example an outreach project to support underrepresented groups for access to higher education. In a third illustrative example, the project is an environmental project, for example, reaching net zero by 2050.

In all of the above example projects, the projects are long-term, lasting around between 2 years to 30 years. In many democratic political systems, the elected politicians may be replaced at the next election in a few years' time whereas decisions they are taking may impact a population for generations.

A system is needed which addresses these challenges by providing a framework enabling a more systematic approach towards developing activities.

### SUMMARY

According to a first aspect of the present disclosure, there is provided a system for improved tracking and accessibility of project development. The system includes at least one project module; an active information module for searching, retrieving and storing information relevant to the at least one project module including a verification program for assessing a validity of said relevant information; and a blockchain module including blockchain. The blockchain module is in data communication with the at least one project module and is configured to irreversibly record actions carried out that are associated with the project module. The at least one project module being accessible by an authenticated user, and the blockchain module is accessible by a verified independent user.

The verification program of the active information module may include instructions, that when executed on a processor, perform the tasks of assessing a validity of the information, and discarding the information if the information is deemed invalid or storing the information if the information is deemed valid.

The at least one project module may include a concept submodule; a planning submodule; and an execution submodule.

Each submodule may be individually data connected to the blockchain for irreversibly recording actions applied to the submodules.

Each project module may include a plurality of decision nodes. Each decision node utilizes user input by the authenticated user wherein, when the authenticated user interacts with a particular decision node, the active information module automatically responds by retrieving and presenting relevant verified information for that specific decision node to facilitate successful user input.

The system may further include an authenticated user database that includes user profiles, where the user profiles include at least one of a user's educational background, a user's professional background, a user's experience from similar projects and/or a user's personal characteristics and values.

The active information module may further include a simulation submodule. The simulation submodule may be configured to: input relevant, verified information relating to the specific decision node; input the user input from the authenticated user; and output a resulting probabilistic simulation and present this to the authenticated user.

The at least one project module may include a plurality of project modules: wherein each of the plurality of project modules may be in data communication with the active information module and the blockchain; wherein the active information module provides information only of relevance to the particular project module; and wherein permission to access the recorded information in the blockchain is granted only to approved users of the associated project module.

The authenticated user may be authenticated via multifactor authentication and cryptographic keys.

The blockchain may be a decentralised blockchain structure.

The active information module may be configured to access a user's profile, and use the information in the user profile to determine what relevant verified information to present to the authenticated user when requesting user input.

The active information module may be configured to: regularly scan information databases and/or the internet to retrieve related up-to-date information relevant to live project of the system; and execute the verification program on said retrieved information.

According to a second aspect of the invention there is provided a method for improved tracking and accessibility of a project development system comprising: accessing a particular project module in a project development system by an authenticated user; presenting the authenticated user with a series of decisions associated with a project of the project module; contemporaneously with presenting the authenticated user with each of the series of decisions, accessing an active information module containing verified information and transmitting verified, relevant information to the authenticated user; requesting user input from the authenticated user; and irreversibly storing user input information from the authenticated user in a blockchain.

The method may further comprise: intermittently searching information databases and/or the internet by the active information module for information relevant to each of the live projects throughout a duration of the corresponding project; and performing a verification process on the retrieved information to access the validity of the retrieved information; and discarding the information if the verification process is failed and storing the information in the active information module if the verification process is passed.

The verification process may further comprise presenting the retrieved information with a verification score, said verification score based on a quantified validity of the information.

### BRIEF DESCRIPTION OF THE DRAWINGS

FIG. 1 is a flowchart of a method for improved project development;

FIG. 2a is a schematic diagram of a system for improved project development;

FIG. 2b is a schematic diagram of the system for improved project development of FIG. 2a in a second state;

FIG. 2c is a schematic diagram of the system for improved project development of FIG. 2a in a third state;

FIG. 2d is a schematic diagram of the system for improved project development of FIG. 2a in a fourth state;

FIG. 2e is a schematic diagram of the system for improved project development of FIG. 2a in a fifth state;

FIG. 2f is a schematic diagram of the system for improved project development of FIG. 2a in a final state;

FIG. 2g is a schematic diagram of the system for improved project development of FIG. 2a in an example alternative final state;

FIG. 3 is a schematic diagram of a system for improved project development according to another example;

FIG. 4 is a schematic diagram of a system for improved project development according to a further example; and

FIG. 5 is a graphical representation of an accountability structure of the project development system of the invention.

### DETAILED DESCRIPTION

Unless otherwise defined, all terms of art, notations and other scientific terms or terminology used herein are intended to have the meanings commonly understood by those of skill in the art to which this invention pertains. In some cases, terms with commonly understood meanings are defined herein for clarity and/or for ready reference, and the inclusion of such definitions herein should not necessarily be construed to represent a substantial difference over what is generally understood in the art.

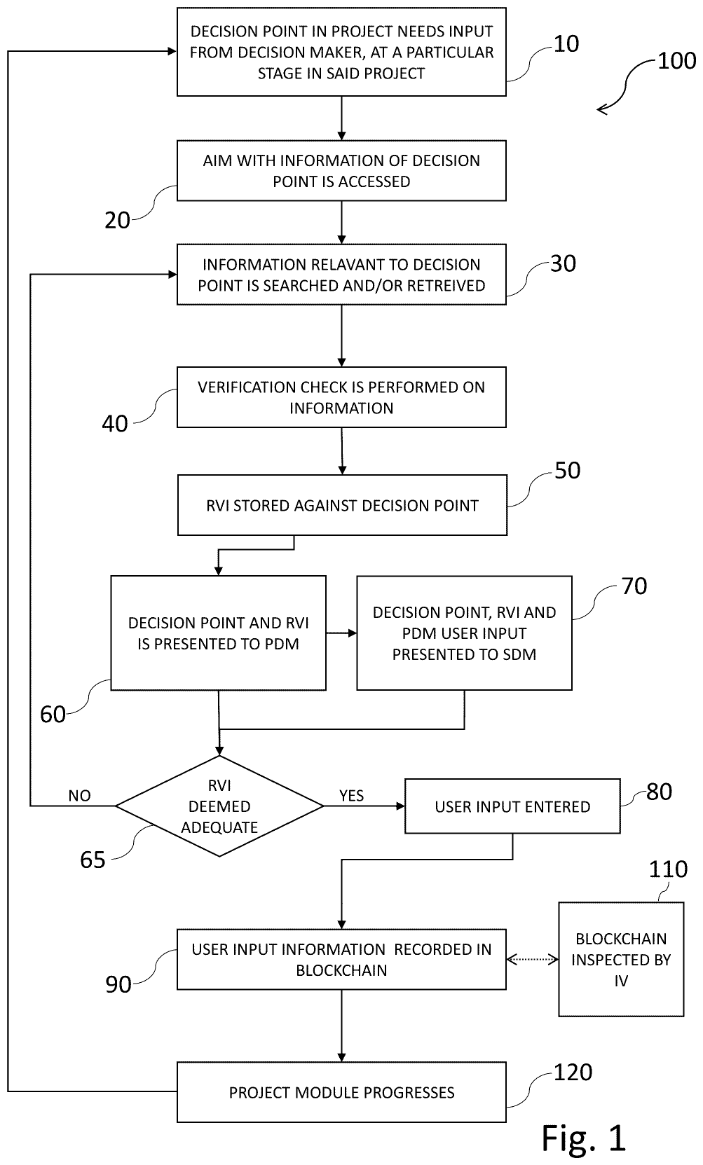

FIG. 1 is a flowchart 100 of a method for improved project development. The method starts at 10 wherein the project needs input from a decision maker at a particular stage in the project.

The method progresses to step 20 wherein an active information module (AIM) with information relating to said decision point is accessed. In some examples, the project has a virtual identification (VID) that permits only access to information relevant to the project to be accessed from the AIM. In another example, it is the decision point which has the VID and only information relevant to that decision of the project is accessible from the AIM. Preferably the AIM is integrated on a cloud-based platform.

The AIM may interact with an authenticated user database comprising user profiles, said user profiles comprising at least one of: a user's educational background, a user's professional background, a user's personal characteristics and values. Information presented to the user may also take into consideration the user profile data.

At step 30 of the method, the AIM is tasked with delivering to the project module relevant and verified information of relevance to the particular decision point. This relevant and verified information of relevance to the particular decision point may also be referred to as RVI. The AIM achieves this task in two main ways. Either the information is already available within the module and has already gone through a verification step. This information is immediately available to be transmitted to the decision point project module space. Alternatively, the AIM sources RVI via the following method. The AIM performs an internet search for up-to-date relevant information to the project module decision point. Once the AIM deems the most relevant information to have been sourced, the AIM performs a verification check (step 40 of method 100). In said verification check a program utilizing artificial intelligence deems whether, on the balance of probability, the information gathered is factually accurate. This verification check may include, for example, requiring a predetermined number of independent sources for the same, or similar within a margin of error, information. The verification check may also include a predetermined list of approved sources such that the predetermined number of independent confirmatory sources is reduced for said approved sources. In contrast for unknown sources, the number of independent confirmatory sources may be higher. In a particular non-limiting example, information for an approved source may prefer between one and three other confirmatory references. In contrast, for a non-approved information source, the information may need to be cross-checked with between 10 and 20 other references. An example of a non-approved information source may be a social media platform. An example of an approved source may be news outlets, government websites or scholarly articles.

In a particular example of the verification check, information gathered may be given a verification score, for example a percentage or a rating out of 10. The verification score may be dependent on the number of independent sources retrieved for particular information and/or the site of these sources. For example, a site deemed more trustworthy would gain a higher verification score. Similarly, a larger number of independent sources would receive a higher verification score. Preferably the verification check is in the form of an algorithm with preprogrammed score factors attributed to various online sources. Yet more preferably the verification check includes machine learning wherein the program adapts the score factor of sources used in the formation of verification scores of particular information. Thus, as the system is used, the verification scores become more reliable over time.

In an optional further step of method 100, the AIM, using applications utilizing learning machines (AI) with RVI as input, establishes a finite number of potential user inputs selections (responses) to the decision. Using the gathered information, the AIM may predict probable outcomes as a result of choosing each of the proposed responses. Using the gathered information, the AIM may also simulate probable outcomes as a result of choosing each of the proposed responses. These simulated probable outcomes may be presented on a display via a graphical user interface.

Preferably, prospective outcomes are provided with an AI-generated outcome score. This outcome score may be based on the deemed likelihood that the outcome will come to fruition generally. Alternatively, a user may input one or more key outcome criteria for which the score is to be based on. In an illustrative example, a first criteria may be cost, a second criteria may be duration and a third criteria may be longevity of the end product. This criteria may be weighted in the AI algorithm such that an outcome score of a given outcome is derived from its comparison with said criteria and also with said order of the criteria.

Once the AIM has deemed that adequate RVI to the decision point has been transmitted, and optionally a finite number of potential responses are presented, the decision is ready to be taken and a user input is required.

At step 50, all RVI is stored with respect to the corresponding decision point.

A primary selector node (PSN) is in information communication with the project module housing the pending decision node. Only an authenticated primary decision maker (PDM) is permitted to access the PSN. This may be controlled by a first cryptographic key. In a first example of step 60, the PDM accesses the PSN and observes that user input is required for a related project. In a second example of step 60, the project module notifies the PDM that user input for a decision point is ready and waiting to be executed. This notification is transmitted to the PSN in the form of an alert/push notification. The PSN may be integrated into an Application on the PDM's personal computer device i.e., mobile phone, tablet, laptop, computer. Via the PSN, the PDM can access the project module to view all of the RVI and the decision requiring input.

The user input from the PDM is transmitted to the secondary decision maker (SDM) along with the decision and RVI, step 70.

An intermediate step 65 between step 60 and step 80 and/or between step 70 and step 80 may be implemented into the method 100 either after the PDM accesses the decision point or after the SDM accesses the decision point, or both. In step 65, it is assessed whether or not the RVI is adequate for the PDM, SDM or both to effectively carry out making of the decision. In some examples, determination that the RVI is adequate is dependent upon the user profile of the PDM and SDM respectively, for example dependent on their education, experience, knowledge, seniority and values to name a few non-limiting examples. If RVI is deemed inadequate the method returns to step 30 wherein information relevant to the decision point is searched and/or retrieved.

At step 80, user input is executed in the form of selection from a predetermined number of proposed decision options.

Preferably the user input is provided by the PDM but executed by the SDM, however other arrangements are possible.

At step 90, the user input relating to taken/selected decision is recorded in blockchain. This record can therefore not be altered or deleted without a cryptographic mark being recorded against future blocks in the blockchain which would identify that the preceding blocks have been tampered with.

Another instance wherein information is irreversibly stored in the blockchain, is wherein there is to be a change of one or more decision makers. In these instances, project history—up to the point in time that decisions have been taken by a first decision maker—is irreversibly stored to provide a record. This provides improved accountability to each decision maker involved in the project. All decisions taken by a particular decision maker are permanently traceable back to the true decision maker. Furthermore, storage in blockchain of the project's development immediately prior to handover provides a new decision maker with a snapshot of a project up to that point, for overview of all necessary information to carry development of the project forward.

At step 110, the blockchain is optionally inspected by an authenticated independent verifier (IV). This independent verifier may be a single person, a group of authenticated persons or the general public. Preferably, the blockchain is inspectable at any time during the project. In this way, available information and situational awareness in earlier parts of the project lifecycle can be derived from the blockchain. More preferably, the blockchain is also inspectable even after the project has been completed.

At step 120, the project progresses. The method may then return to step 10 wherein a subsequent decision point in the project needs user input from the PDM (e.g., a project leader). The method may then cycle through steps 10 to 90 for the subsequent decision point.

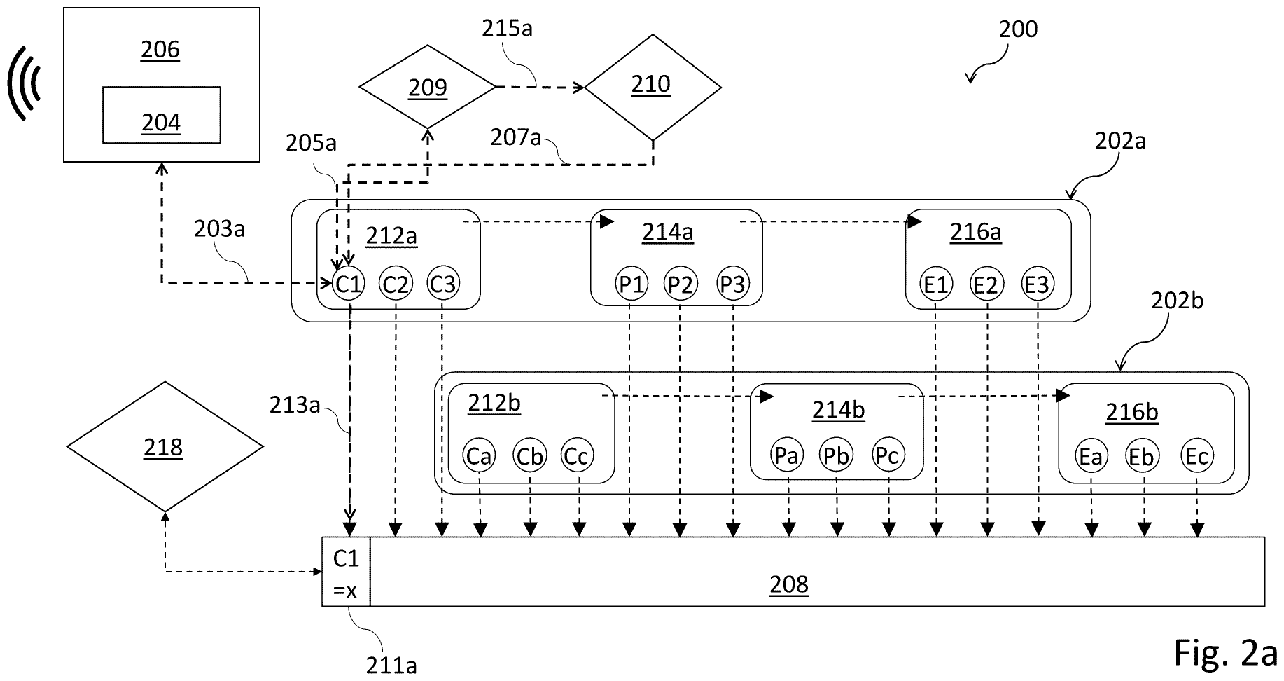

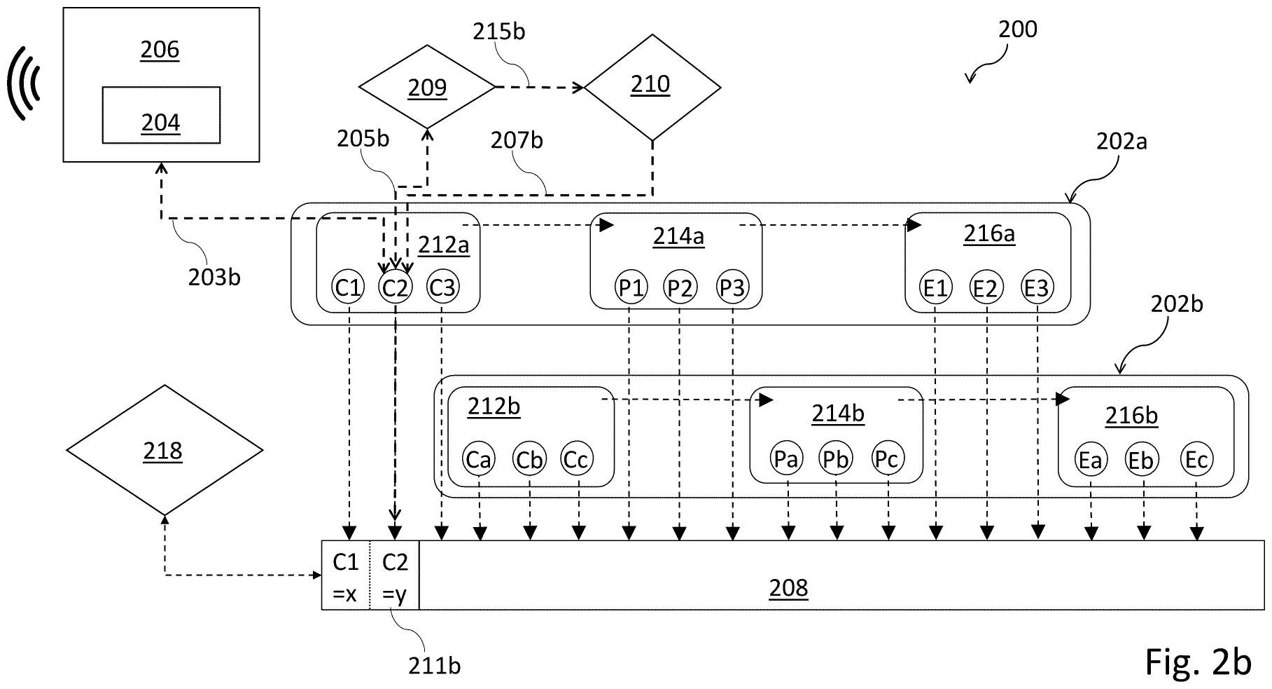

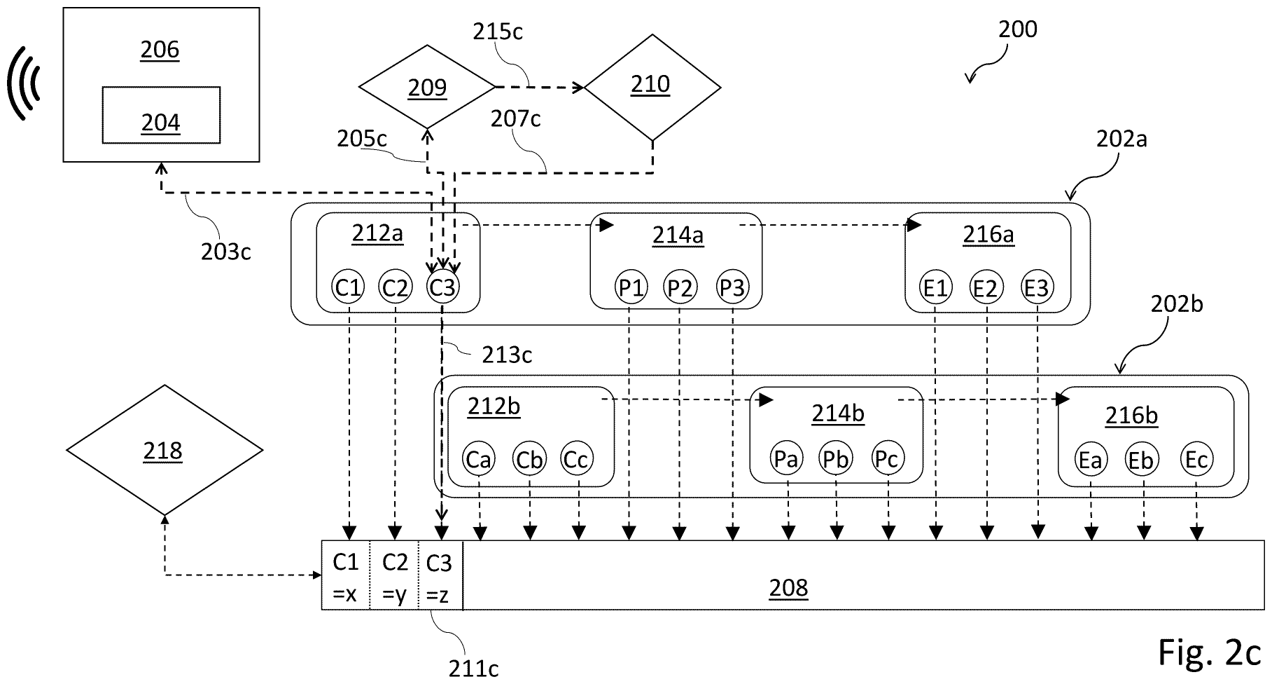

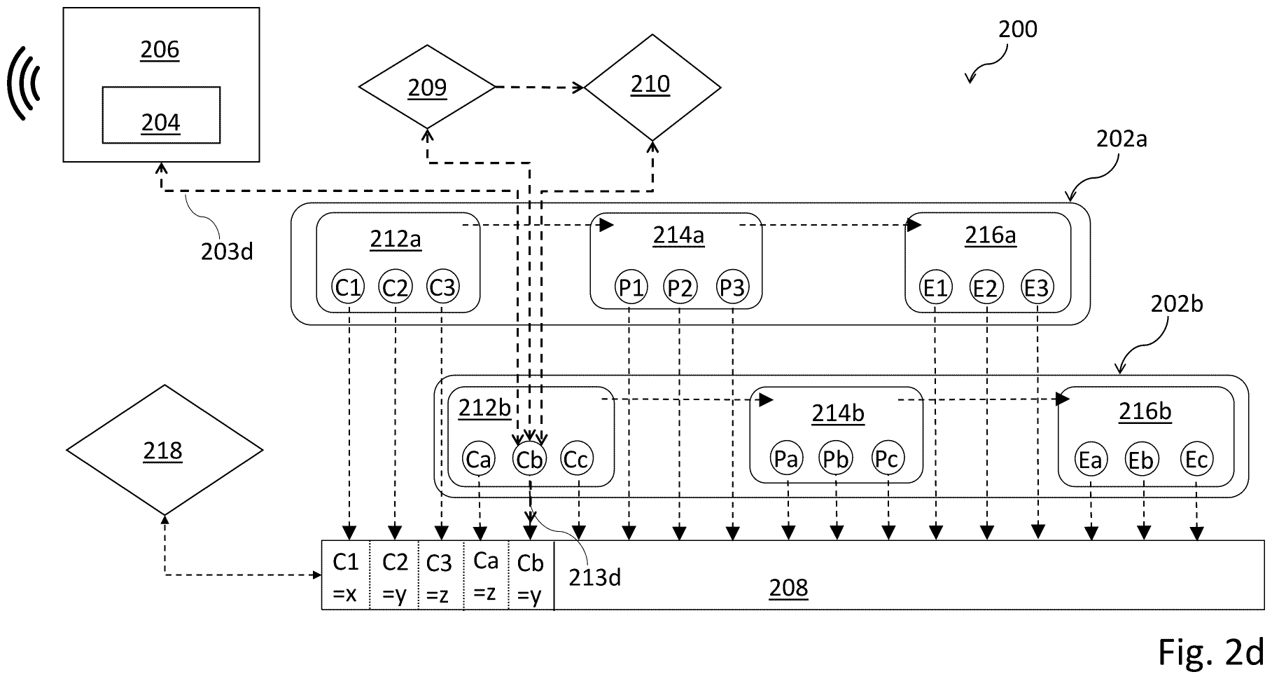

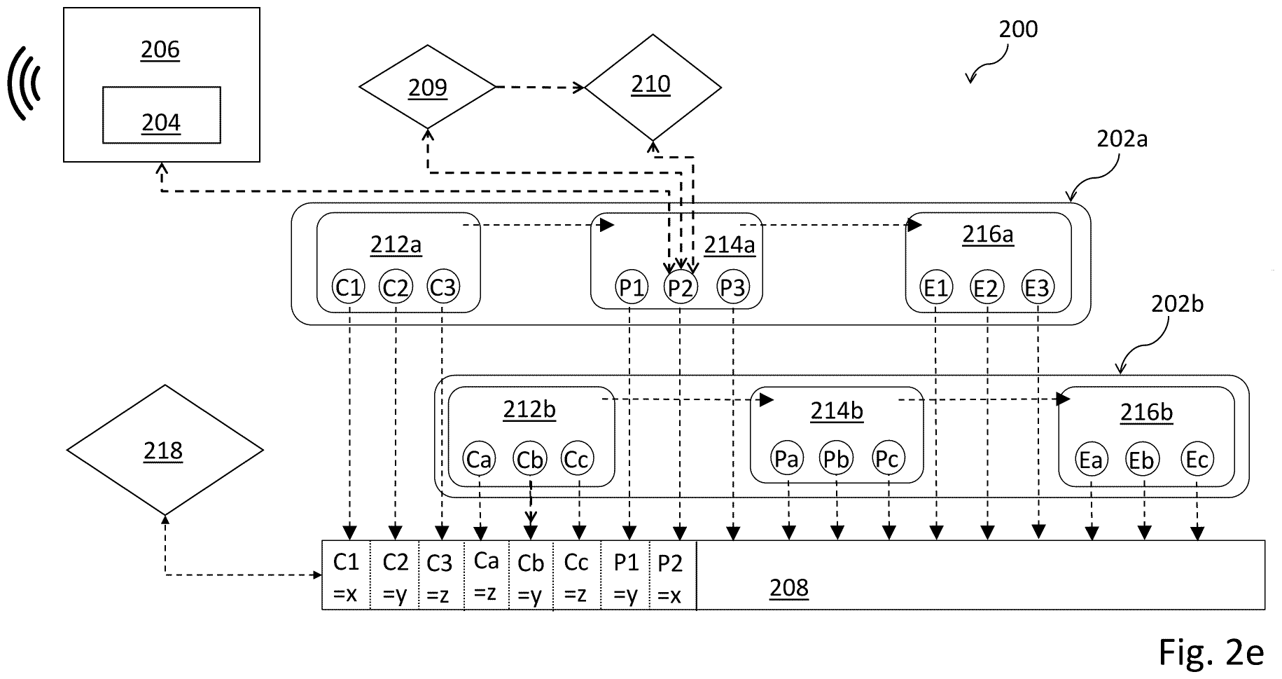

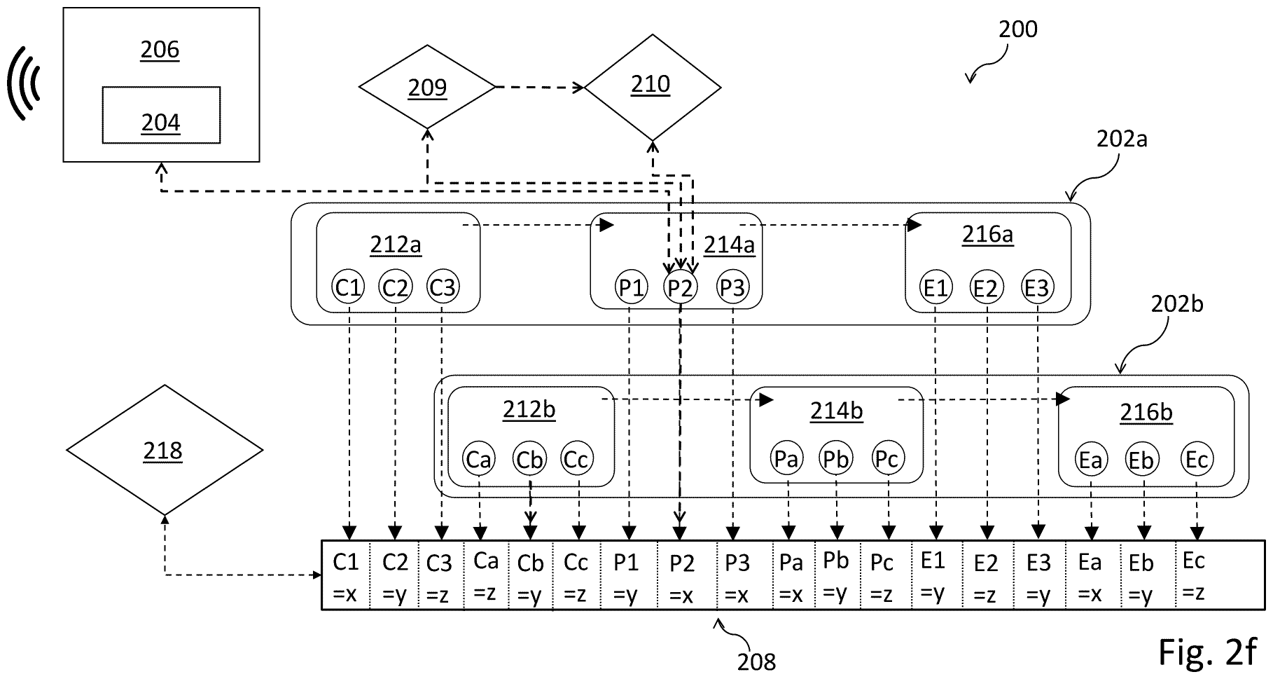

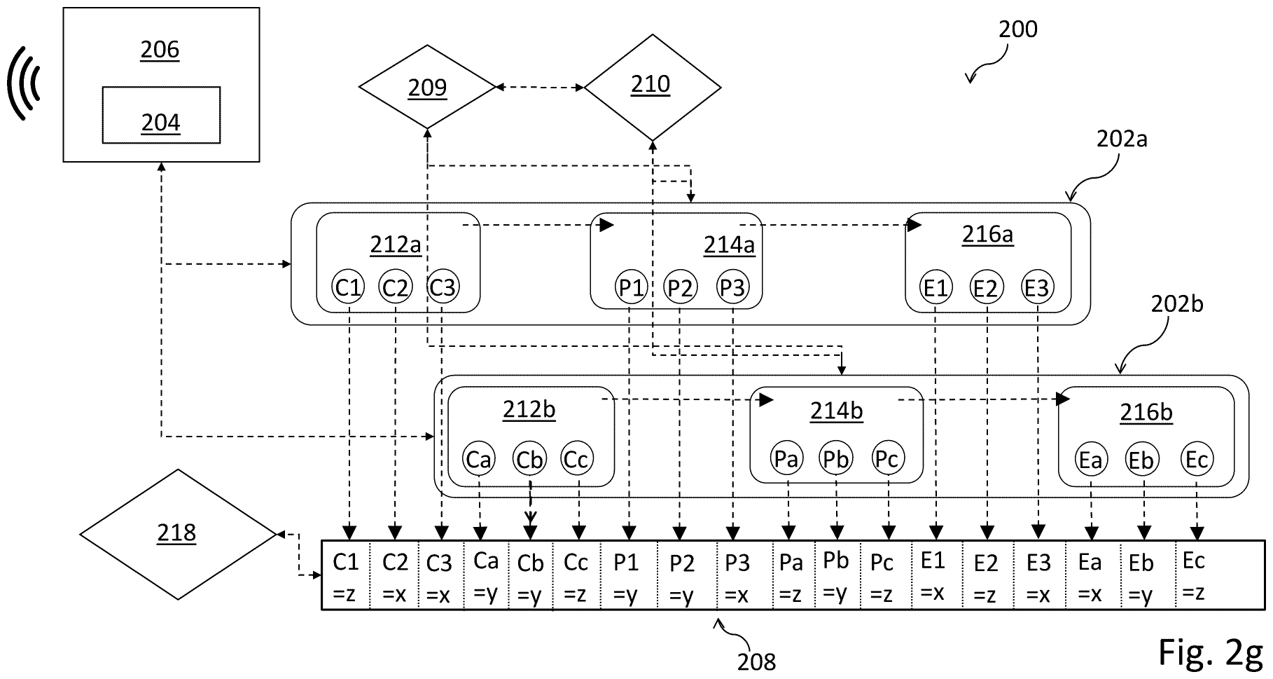

FIGS. 2a to 2g are schematic diagrams for a system 200 for improving project development. In particular, FIGS. 2a to 2g are schematic diagrams for a system 200 that improve accountability during a project development program at various stages of use.

FIG. 2a is a schematic diagram of the system 200 for improved project development at a first stage of said project. The system has a first project module 202a, a second project module 202b, a blockchain module 208, an AIM 206, a PSN 209, an SSN 210, and an IV node 218.

The AIM 206 has a verification program 204 for assessing a validity of information found and retrieved by the AIM 206.

The first project module 202a has a first concept submodule 212a, a first planning submodule 214a, and a first execution submodule 216a. The first concept submodule 212a has a series of concept decision nodes C1, C2, C3. The first planning submodule 214a has a series of planning decision nodes P1, P2, P3. The first execution submodule 216a has a series of execution decision nodes E1, E2, E3. Similarly, the second project module 202b has a second concept submodule 212b, a second planning submodule 214b, and a second execution submodule 216b. The second concept submodule 212b has a series of concept decision nodes Ca, Cb, Cc. The second planning submodule 214b has a series of planning decision nodes Pa, Pb, Pc. The second execution submodule 216b has a series of execution decision nodes Ea, Eb, Ec. The decision nodes having a quantity of three in each submodule is illustrative only and a greater or fewer number of decision nodes is possible for each submodule.

The AIM is an online module allowing it to access the internet. The project modules are in data communication with the AIM 206, the PSN node 209, and the SSN node 210, and the blockchain 208. Preferably, the data communication is a wireless communication, more preferably the wireless communication is over an internet protocol. The blockchain module 208 is in data communication with the independent verifier node 218. Data connectivity between the elements of the system is demonstrated by light-dashed lines.

The system 200 shows two project modules 202a, 202b, however this is illustrative only and any number of project modules is possible.

Chronological functioning of system 200 will now be explained as follows.

A first project, associated with a first project module 202a commences. The first project module 202a determines that there is an unresolved decision node, e.g. decision node C1 in an adjacent stage in the first project. Thus, the first project module 202a activates access of the AIM 206 with instructions for the AIM to analyze a decision point associated with the decision node C1 and to provide RVI. The AIM 206 responds to this request by supplying RVI to the first project module 202a where it is stored in data storage space linked to the decision node C1. This is demonstrated by a first dark-dashed line 203a, seen in FIG. 2a.

The system 200 may be passive in which it waits to be accessed by either the PDM through the PSN 209 or the SDM through the SSN 210. In a particular example, the PDM accesses the first project module 202a, as demonstrated by dashed-line 205a in FIG. 2a, which then presents a decision point associated with concept decision node C1 along with the RVI and requests a selection. The PDM makes their selection, which is transmitted via 215a to the SSN 210 by the PSN 209. The SDM then views the selection, along with the decision point and the verified information and confirms the selection for the concept decision node C1, as demonstrated by dashed-line 207a, seen in FIG. 2a.

Alternatively, the system 200 may be activated whereby the first project module 202a sends 205a an alert to one or more of the PSN 209 and/or the SSN node 210 to inform the PDM and/or the SDM (project responsible) that a decision is waiting to be taken for an associated project, e.g., the first project. The process then continues as above for the passive system. User's interacting with the PSN 209 or the SSN node 210 may be required to fulfill a multifactor authentication process. For example, the primary and/or secondary selector nodes may request biometric identification and a personal cryptographic key from the primary decision maker and/or the secondary decision maker.

The selected decision is stored in a block in the blockchain module 208, as demonstrated by line 213a. In the schematic diagram of FIG. 2a this is represented by block 211a in which it has been recorded that C1=x, that is decision x was selected for concept decision node C1. In some examples of the invention, it is also recorded in a block the PDM whom selected the decision and the SDM (project responsible) whom executed the decision. Preferably, the blockchain is a decentralized blockchain structure.

FIG. 2b is a schematic diagram of the system 200 for improved project development in a second state, where the second state is a later stage in the project, e.g., the first project. A new decision of concept decision node C2 in the concept submodule 212a has become due. In a similar manner as above, the first project module 202a activates access of the AIM 206 with instructions for the AIM to analyse the decision point associated with the concept decision node C2 and provide RVI. The AIM 206 responds to this request by supplying RVI to the first project module 202a where it is store in a storage space linked to the concept decision node C2. This is demonstrated by dark-dashed line 203b, seen in FIG. 2b. The PDM then either passively or actively becomes aware of the pending decision point and is presented with the RVI that is relevant only to the new decision point of concept decision node C2, as demonstrated by dark-dashed line 205b. As demonstrated by dash-line 215b, the PDMs decision is transmitted to the SSN 210 from the PSN 209. The SSN then confirms the selection for concept decision node C2, as demonstrated by dark-dashed line 207b, seen in FIG. 2b. The decision is stored in a subsequent block 211b in the blockchain 208. For example, the decision C2=y is stored in block 211b. Block 211b also contains a cryptographic stamp of the previous block 211a so, as an illustrative example, block 211b will have the unique code C2=y (C1=x) which identifies the decision taken at C2 (by whom and including a timestamp) and the decision taken at C1 (by whom and including a timestamp). In this way, project history is irreversibly recorded.

FIG. 2c is a schematic diagram of the system 200 for improved project development in a third state, where the third is a later stage in a project, than the second stage. A new decision of concept decision node C3 in the concept submodule 212a has become due. In a similar manner as above, the first project module 202a activates access of the AIM 206 with instructions for the AIM to analyse the decision point associated with the decision node C3 and provide RVI. The AIM 206 responds to this request by supplying RVI to the first project module 202a where it is store in a storage space linked to the concept decision node C3. This is demonstrated by dark-dashed line 203c, seen in FIG. 2c. The PDM then either passively or actively becomes aware of the pending decision point and is presented with the RVI that is relevant only to the new decision point of concept decision node C3, as demonstrated by dark-dashed line 205c. As demonstrated by dash-line 215c, the PDMs decision is transmitted to the SSN 210 from the PSN 209. The SSN then confirms the selection for concept decision node C3, as demonstrated by dark-dashed line 207c, seen in FIG. 2c. The decision is stored in a subsequent block 211c in the blockchain 208 as demonstrated by dark-dashed line 213c. For example, the decision C3=z is stored in block 211c. Block 211c also contains a cryptographic stamp of the previous two blocks 211a, 211b so, as an illustrative example, block 211c will have the unique code C3=z (C2=y (C1=x)) which identities the decision taken at C3, C2 and C1 (by whom and including a timestamp).

In the example system 200, the completion of concept decision node C3 signals the end of the concept phase of the project. The project will then move on to the planning phase of the project controlled by the planning submodule 214a. The system may comprise software programmed to send an alert to the independent verifier node 218 on completion of the concept phase of the project. The independent verifier node 218 may include a plurality of personal computers of authenticated verifiers having an associated Application downloaded thereon. The alert may be in the form of a notification pushed to the Application.

As mentioned above, the system 200 has two project modules 202a, 202b. The projects associated with the project modules 202a, 202b may have overlapping timeframes. In the example of system 200, the project modules 202a, 202b have overlapping timeframes so that the second project associated with the second project module 202b starts as the first project associated with first project module 202a finishes its concept stage.

The projects associated with the first project module 202a and the second project module 202b may be related and interdependent. Alternatively, the projects may be unrelated.

With reference to FIG. 2d, the system 200 is now executing the concept phase of the second project module 202b via the concept submodule 212b. The process for carrying out decision making at the concept decision nodes Ca, Cb, Cc may be substantially similar to that of the decision making relating to concept decision nodes C1, C2, C3 of project module 202a. Thus, the second project module 202b determines that there is an unresolved decision node in an adjacent project phase in the second project. In the example of FIG. 2d the next unresolved decision node is concept decision node Cb. The second project module 202b activates access of the AIM 206 to analyse the decision point associated with the concept decision node Cb and provide RVI. This is demonstrated by a first dark-dashed line 203d.

The PSN 209 becomes aware of the pending decision point, takes a selection based on the verified information supplied by the active information module, transmits their decision to the SSN 210, where the SSN 210 confirms the selected decision.

The selected decision is stored in a block in the blockchain module 208, as demonstrated by line 213d, seen in FIG. 2d. In the example of FIG. 2d, decisions made to the second project module 202b are stored in the same blockchain as decisions made to the first project module 202a. The blockchain data is retrievable by independent verifier node 218, thus decision data relating to both the project modules 202a and 202b is retrievable by independent verifier node 218. For example, the particular code representing the current block in the blockchain module 208 includes a cryptographic stamp of all previous decision is Cb=y (Ca=z (C3=z (C2=y (C1=x)))). The code representing the current block would be different had the decision made been different and, optionally had the decision been made by different PDMs.

FIG. 2e is a schematic diagram of the system 200 wherein the project module 202a has moved onto the planning phase of the first project. The system 200 behaves in a similar manner as in the concept stage with the exception that decision points are relating to the planning of the project, e.g., planning the first project. In some examples, the PDM in the planning stage is different than the PDM in the concept phase.

Preferably, the SDM (project responsible) is the same throughout the lifetime of the project from conception to completion. In this way, oversight of the project is well maintained. However, the particular arrangement of the system mitigates hand-over issues from PDM and/or SDMs. Since the active information module 206 provides up-to-date relevant information to the new project leaders (PDM)/project responsibles (SDM), there is less requirement for particular expertise, knowledge or experience of the project. Furthermore, since all past decisions are irreversibly stored in the blockchain, project history can be readily accessed and analyzed.

FIG. 2f shows the system 200 with a complete blockchain for a completed project. The code in the blockchain module 208 provides a recording of all of the authenticated user input throughout the project.

FIG. 2g shows the system 200 of a complete blockchain module 208 for a completed project wherein different user input was provided and thus the blockchain has a different code.

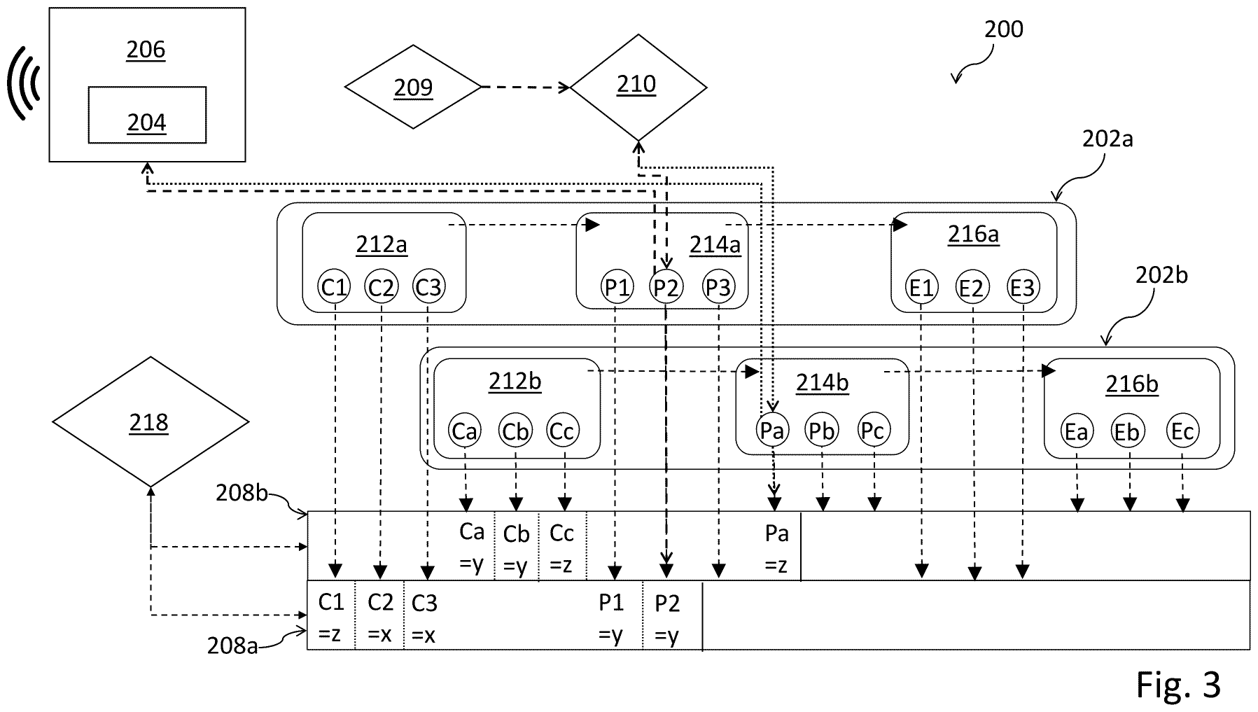

FIG. 3 shows system 200 with separate blockchain modules 208a, 208b for recording user input for each associated project module 202a, 202b. This has the advantage that inspection of the blockchain for the individual project modules 202a, 202b can be controlled. For example, some independent verifiers may be granted accesses to the blockchain for the first project module 202a but not to the blockchain for the second project 202b, and vice versa.

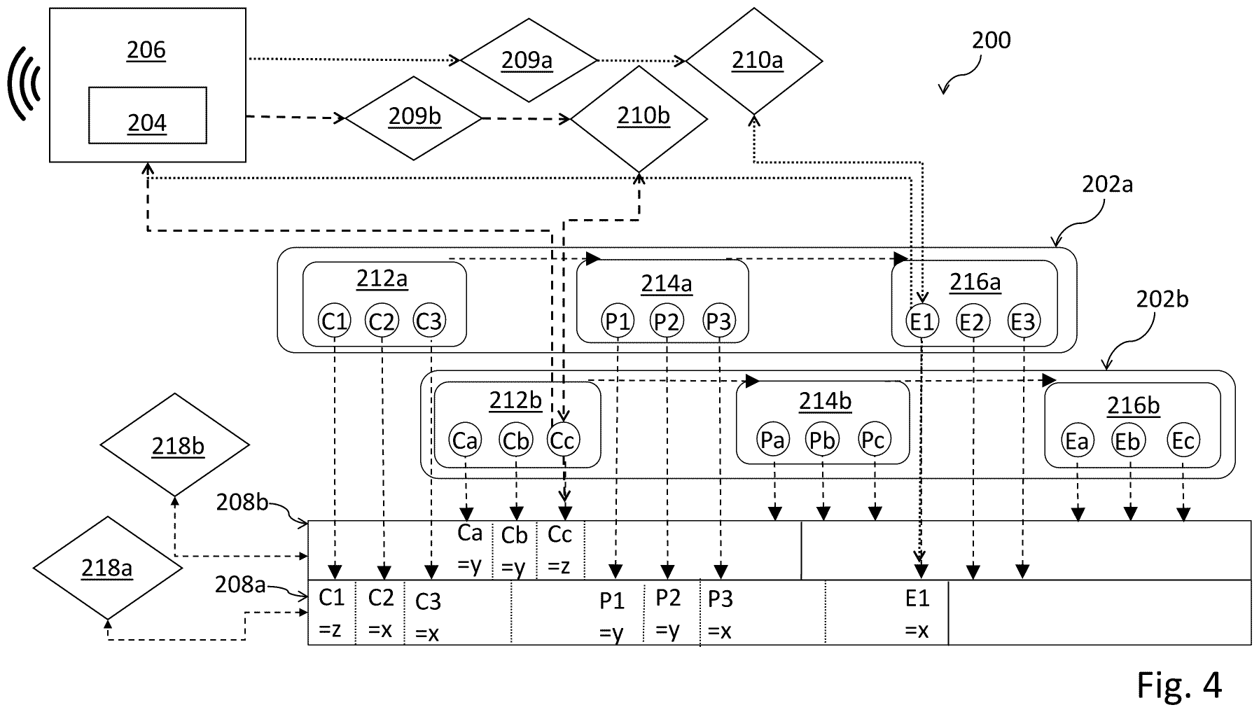

FIG. 4 shows the system 200 having modified permission access from various nodes, and thus various authenticated users, to the different project modules 208a, 208b. As shown in FIG. 4, the first project module 202a is in information communication with a first primary selector node 209a and with a first secondary selector node 210a. The first primary selector node 209a and the secondary selector node 210a are not however in information communication with the second project module 202b. Whereas, the second project module 202b is in information communication with a second primary selector node 209b and with a second secondary selector node 210b. The second primary selector node 209b and the second secondary selector node 210b are not however in information communication with the first project module 202a. Decision data relating to the first project module 202a and associated with the first PSN and the first SSN is stored in the first blockchain module 208a and is in data communication with a first IV node 218a. Decision data relating to the second project module 202b and associated with the second PSN 209b and second SSN is stored in the second blockchain module 208b and is in data communication with a first IV node 218b. In this way, permission of access to data records associated with different project modules can be better controlled.

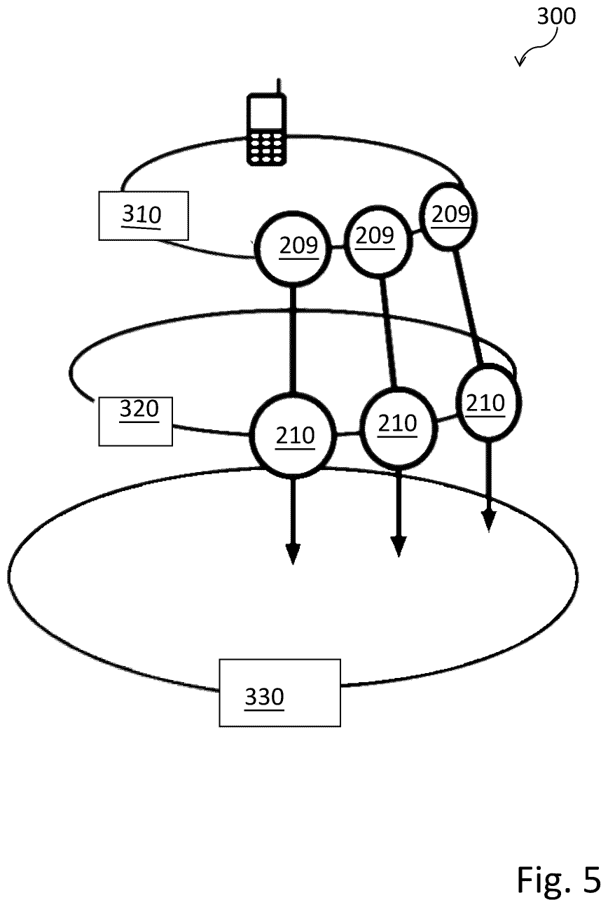

FIG. 5 is a graphical representation of an accountability structure 300 of the project development system 200. A first level of accountability 310 is associated with the primary selector nodes 209 and the PDM, for example, politicians. A second level of accountability 320 is associated with the secondary selector nodes 210 and the SDM, for example, project responsible. A third and final level of accountability 310 is associated with the IV 218, for example a group of people given special permissions or the general public.

### Example 1: The Herein Described System and Method as a Testbench for Particle Physics Experiments

Decision Nodes for Particle Physics: Decision nodes within the system can be define that are specific to particle physics experiments. These nodes could represent critical points in the experimental process where decisions need to be made.

Information Retrieval for Particle Physics: The active information module (AIM) can be configured to retrieve information relevant to particle physics experiments. This involves accessing particle physics databases, experiment results, theoretical models, and other relevant sources. This is an example of step 30 of the method.

Verification Process for Particle Physics: The verification program within the AIM can be enhanced to accommodate the unique characteristics of particle physics data. Algorithms can be developed that assess the validity of experimental results, considering factors such as statistical significance, reliability of sources, and consistency with theoretical predictions. This is an example of step 40 of method 100.

Prediction and Simulation for Particle Physics: Prediction and simulation capabilities can be integrated within the AIM to predict, and optionally model, potential outcomes of particle physics experiments. This could involve predicting particle interactions, decay processes, and other phenomena based on the input data and user decisions.

User Profiles for Particle Physicists: The user profiles can be modified within the system to include information relevant to particle physicists, such as educational background, research expertise, and specific areas of interest within particle physics. This is an example of step 20 of method 100.

Blockchain Recording for Accountability: The blockchain structure can be maintained for recording decisions and actions taken during particle physics experiments. This ensures a transparent and immutable record of the experiment's development. This is an example of step 90 of method 100.

Integration with Particle Physics Tools: The AIM can be integrated with existing particle physics tools and software to streamline data access and analysis. This may involve collaboration with particle physics research institutions and laboratories.

Multifactor Authentication for Particle Physicists: Multifactor authentication mechanisms can be implemented, tailored to the needs and security standards of particle physicists accessing the system. This is an example of step 90 of method 100.

Regular Scanning for Particle Physics Updates: The AIM can be configured to regularly scan particle physics literature, experiment databases, and relevant online sources to retrieve up-to-date information for ongoing experiments.

Collaboration with Particle Physics Community: Collaboration channels with the particle physics community can be established to gather feedback, improve the system based on the evolving needs of researchers, and ensure broad acceptance within the field.

### Example 2: Upgrade a Water Treatment Plant to Ensure Clean and Safe Drinking Water to a Community

The active information module (AIM) will maintain verification process, information adaption and prediction process in concept, planning and execution phase of the project.

Decisions will include how to re-use and/or modify existing infrastructure, ensure political consensus, funding, plan necessary treatment processes and distribution system including new pipes, pumps and storage tanks, to name a few non-limiting examples. Multiple solutions will be considered.

Information Retrieval for concept phase: The AIM may use AI and learning machine algorithms to rate former or ongoing similar or related project to estimate cost benefits, critical success factors and impacts on society. This will require assistance of professionals from this and similar sectors as well as local data or data from comparable geographical areas and similar projects. Risk and vulnerability analysis (RVA), taking economic and political aspects into account, may be linked to and notified to the decision nodes.

Verification Process for water plant: The verification program within the AIM will ensure correctness of reports from former projects as well as the data's relevance. Data, biased by former decisions makers political or personal views are preferably considered. This is an example of step 30 of the method.

Characteristics public large-scale projects: Algorithms can be developed to use and weight parameters. Self-learning systems and continuous improvement as basic principles in neural networks and deep learning, and data reliability will improve over time. As a result, consequences of decisions in complex projects will be clearer and give the decision maker opportunity to continue leading in a desired direction and (according to his/her view) take the optimized decisions for the society.

Simulation of project outcome and degree of success: Simulation capabilities can be integrated within the AIM to model potential outcomes depending on decisions and projection plans. This may incorporate predicting future results based on results for former projects.

User Profiles for decision makers in water plant projects: The user profiles can be established before or on project start-up and modified during the project lifecycle. Relevant parameters will include project experience, political doctrine and experience, educational background, and management style. This is an example of intermediate step 65 of method 100.

Blockchain Recording for Accountability: The blockchain structure can be maintained for situational awareness, recording decisions and actions taken during project execution phase. This ensures a transparent and immutable record of the project's progress. This is an example of step 90 of method 100.

Integration with project management tools: the above-described system may be integratable with existing resource- and project management systems to ensure optimal control in concept, planning and execution phase of the project's lifecycle, independent of duration of the project.

Multifactor Authentication for project participants: Multifactor authentication mechanisms can be implemented, tailored to the needs and security standards of the project.

Regular Scanning for relevant information in ongoing parallel and similar projects: The AIM can be configured to regularly scan political, environmental, economic conditions that may influence the project's framework or scope, and hence update situational awareness for the decision maker. New information will be time-stamped when added to the blockchain to document availability of information at any stage of project execution.

Collaboration with political peers and municipal administration: Collaboration channels relevant stakeholders can be established to gather feedback, improve the system based on the evolving needs, and ensure broad acceptance.

After project execution or on major milestones the feedback-loop of the system will ensure continuous improvement of the model. This provides improved success rate for future projects as well as maintained accountability of involved politician and decision maker.

Having described preferred examples of the invention it will be apparent to those skilled in the art that other embodiments incorporating the invention may be used. These and other examples of the invention illustrated above are intended by way of example only and the actual scope of the invention is to be determined from the appended claims.

What is claimed is:

1. A system for improved tracking and accessibility of project development comprising:
at least one project module accessible by at least one authenticated user;
an active information module used to search for, retrieve and store information relevant to the at least one project module, the active information module including a verification program used to assess a validity of the relevant information; and
a blockchain module accessible by at least one verified independent user, the blockchain module including a blockchain, the blockchain module being in data communication with the at least one project module and configured to irreversibly record actions carried out that are associated with the project module in the blockchain.

2. The system of claim 1, wherein the verification program of the active information module comprises instructions, that when executed on a processor, perform the tasks of:
assessing a validity of the information; and
discarding the information if the information is deemed invalid or storing the information if the information is deemed valid.

3. The system of claim 1, wherein the at least one project module comprises:
a concept submodule;
a planning submodule; and
an execution submodule.

4. The system of claim 3, wherein each submodule is individually data connected to the blockchain for irreversibly recording actions applied to the submodules.

5. The system of claim 1, wherein each project module comprises a plurality of decision nodes, each decision node being responsive to user input by the authenticated user wherein, when the authenticated user interacts with a particular decision node, the active information module automatically responds by retrieving and presenting relevant verified information for that specific decision node to facilitate successful user input.

6. The system of claim 1, further comprising an authenticated user database comprising user profiles, said user profiles comprising at least one of:
a user's educational background;
a user's professional background;
a user's personal characteristics and values.

7. The system of claim 5, wherein the active information module further comprises a simulation submodule, the simulation submodule is configured to:
input relevant, verified information relating to the specific decision node;
input the user input from the authenticated user; and
output a resulting probabilistic simulation and present this to the authenticated user.

8. The system of claim 1, wherein the at least one project module comprises a plurality of project modules:
wherein each of the plurality of project modules is in data communication with the active information module and the blockchain;
wherein the active information module provides information only of relevance to the particular project module; and
wherein permission to access the recorded information in the blockchain is granted only to approved users of the associated project module.

9. The system of claim 1, wherein the authenticated user is authenticated via multifactor authentication and cryptographic keys.

10. The system of claim 1, wherein the blockchain is a decentralised blockchain structure.

11. The system of claim 6, wherein the active information module is configured to access a user's profile, and use the information in the user profile to determine what relevant verified information to present to the authenticated user when requesting user input.

12. The system of claim 2, wherein the active information module is configured to:
regularly information databases and/or scan the internet to retrieve related up-to-date information relevant to one or more live projects of the system; and
execute the verification program on said retrieved information.

13. A method for improved tracking and accessibility of a project development system comprising:
accessing a particular project module in a project development system by an authenticated user;
presenting the authenticated user with a series of decisions associated with a project of the project module;
contemporaneously with presenting the authenticated user with each of the series of decisions, accessing an active information module containing verified information and transmitting verified relevant information to the authenticated user;
requesting user input from the authenticated user; and
irreversibly storing user input information from the authenticated user in a blockchain.

14. The method of claim 13, further comprising:
intermittently searching information databases and/or the internet by the active information module for information relevant to one or more of the projects throughout a duration of the corresponding project;
performing a verification process on the retrieved information to access the validity of the retrieved information; and
discarding the information if the verification process is failed and storing the information in the active information module if the verification process is passed.

15. The method of claim 14, wherein the verification process further comprises presenting the retrieved information with a verification score, said verification score based on a quantified validity of the information.
